(19) United States
(12) Patent Application Publication
(10) Pub. No.: US 2017/0362100 A1
(43) Pub. Date: Dec. 21, 2017

(54) WATER SOFTENER VALVE MECHANISM AND SYSTEM THEREOF

(71) Applicant: Xiamen Runner Industrial Corporation, Xiamen (CN)

(72) Inventors: FENG-SHUN ZHAN, Xiamen (CN); YU-WEI LIAN, Xiamen (CN)

(21) Appl. No.: 15/625,111

(22) Filed: Jun. 16, 2017

(30) Foreign Application Priority Data
Jun. 17, 2016 (CN) 201610428150.1

(51) Int. Cl. C02F 1/42; F16K 31/04; F16K 11/074; C02F 101/10

(52) U.S. Cl. CPC C02F 1/42; F16K 11/074; F16K 31/043; C02F 2209/00; C02F 2201/005; C02F 2101/10; C02F 2303/22; C02F 2303/16

(57) ABSTRACT

A water softener valve mechanism includes a body provided with a first inlet, a first outlet and a first discharge. The body has a static valve plate provided with a first passage, a second passage, a third passage, a fourth passage, a fifth passage and a sixth passage and a second discharge and a dynamic plate rotatable relative to the static plate and having an elongated recess defined in a side face of the dynamic plate and a third inlet in communication with the first inlet of the body and to selectively communicate with the first passage, the second passage, the third passage, the fourth passage, the fifth passage and the sixth passage, and a driving device mounted inside the body to drive the dynamic valve plate to rotate.

### CROSS REFERENCE

This application claims the priority of Chinese Application No. 201610428150.1, filed on Jun. 17, 2016 and the entirety thereof is herein incorporated in reference.

### TECHNICAL FIELD

The preferred embodiment of the present invention is related to a field of water softener and, more particularly, to a water softener valve mechanism and system thereof.

### BACKGROUND OF THE INVENTION

Nowadays, the presence of certain metal ions like calcium and magnesium principally as bicarbonates, chlorides, and sulfates in water causes a variety of problems. Hard water leads to the buildup of limescale, which can foul plumbing, and promote galvanic corrosion. In industrial scale water softening plants, the effluent flow from the re-generation process can precipitate scale that can interfere with sewage systems. Water softening is the removal of calcium, magnesium, and certain other metal cations in hard water. The resulting soft water is more compatible with soap and extends the lifetime of plumbing. Water softening is usually achieved using lime softening or ion-exchange resins. Water softeners are well known in the art and typically include a raw water source, a treatment tank containing an ion exchange resin, a brine tank containing a brine solution, and a control valve for directing fluids between the source, the tanks and a drain or other output.

Water softening occurs by running water through the ion exchange resin, which replaces the calcium and magnesium cations in the water with sodium cations. As the ion exchange process continues, the resin eventually loses its capacity to soften water and must be replenished with sodium cations. The process by which the calcium and magnesium ions are removed, the capacity of the ion exchange resin to soften water is restored, and the sodium ions are replenished is known as regeneration.

The existing art, for example, U.S. Pat. No. 8,535,540 ('540) describes a control valve device for a water softener and the system thereof, wherein the system includes a piston, wherein movement of the piston between a plurality of different positions is operative to change the flow of water through the orifices.

From the above description abstracted from '540 patent, it is to be noted that the patent is focused on the piston to control open or close of variety of orifices as well as different fluid communication between pipes or conduits.

After study current art, it is noted that numerous valve structures are provided commercially. However, they are either complicated in structure or require additional control modules to control various water softening processes.

### SUMMARY OF THE INVENTION

It is an objective of the preferred embodiment of the present invention to provide a water softener valve mechanism adapted to be in fluid communication with a resin tank containing therein resins for softening hard water and a brine tank containing therein salt water for cleaning resins in the resin tank. The valve mechanism constructed in accordance with the embodiment of the present invention has a valve body provided with a first inlet, a first outlet and a discharge for discharging waste such as calcium, magnesium. Furthermore, a static valve plate and a dynamic valve plate rotatably corresponding to the static valve are provided inside the valve body to selectively channel different waterways to undergo various water softening processes.

A further objective of the embodiment of the present invention is to have a water softener valve mechanism having a body provided with a first inlet, a first outlet and a first discharge. The body further has a static valve plate provided with a first passage, a second passage, a third passage, a fourth passage, a fifth passage and a sixth passage respectively and radially defined through a surface of the static valve plate and a second discharge defined through a central portion of the static valve plate to have the first passage, the second passage, the third passage, the fourth passage, the fifth passage and the sixth passage radially located around the second discharge; and a dynamic plate rotatable relative to the static plate and having an elongated recess defined in a side face of the dynamic plate and a third inlet in communication with the first inlet of the body and to selectively communicate with the first passage, the second passage, the third passage, the fourth passage, the fifth passage and the sixth passage; and a driving device mounted inside the body to drive the dynamic valve plate to rotate.

A further objective of the embodiment of the present invention is that the driving device includes a motor, a master gear securely connected to the motor to be rotatable relative to the motor, and a planetary gear meshed with the master gear to be driven by the master gear, the planetary gear is securely connected to the dynamic valve plate to provide a driving force to the dynamic valve plate to rotate relative to the static valve plate.

A further objective of the embodiment of the present invention is that a plurality photo sensors are mounted inside the body and photo pads mounted on the planetary gear to allow the photo sensors to detect angular positions of the dynamic valve plate after rotation.

A further objective of the embodiment of the present invention is that check valves are installed respectively in the fourth passage, the fifth passage and the sixth passage.

A further objective of the embodiment of the present invention is that a water softener system includes a body having a first inlet, a first outlet, a static valve plate immovably located inside the body and having multiple passages radially defined through a face of the static valve plate and a second discharge centrally defined through the face thereof to have the second discharge surrounded by the passages and a dynamic valve plate movable relative to the static plate and having a third inlet selectively communicating with the first inlet and one of the passages of the static valve plate and an elongated recess with a central portion thereof aligned and communicating with the second discharge and a far end thereof either selectively communicating with one of the passages or having no communication with any of the passages while the third inlet is still aligned and communicating with one of the passages;
an ejector securely mounted on the body and having a main inlet selectively communicating with the first inlet of the body and a negative pressure inlet selectively communicating with the main inlet;
a resin tank having a second inlet selectively communicating with the first inlet of the body, a second outlet selectively communicating with the first inlet and the discharge of the body; and
a brine tank having a salt pipe extending outwardly to selectively communicate with the negative pressure inlet of the ejector such that movement of the dynamic valve plate allows the communication between the third inlet and one of the passages of the static valve plate to have various fluid communications in filtering phase, reverse phase, regenerating phase, cleansing phase and water supplementing phase.

A further objective of the embodiment of the present invention is that the passages of the static valve plate include a first passage, a second passage, a third passage, a fourth passage, a fifth passage and a sixth passage respectively and radially defined through the face of the static valve plate.

A further objective of the embodiment of the present invention is that a driving device mounted inside the body to drive the dynamic valve plate to move.

A further objective of the embodiment of the present invention is that the driving device includes a motor, a master gear securely connected to the motor to be rotatable relative to the motor, and a planetary gear meshed with the master gear to be driven by the master gear, the planetary gear is securely connected to the dynamic valve plate to provide a driving force to the dynamic valve plate to rotate relative to the static valve plate.

A further objective of the embodiment of the present invention is that a plurality photo sensors mounted inside the body and photo pads mounted on the planetary gear to allow the photo sensors to detect angular positions of the dynamic valve plate after rotation.

A further objective of the embodiment of the present invention is that check valves installed respectively in the fourth passage, the fifth passage and the sixth passage.

A further objective of the embodiment of the present invention is that the dynamic valve plate is rotated to a position where the third inlet is communicating with the first passage of the static valve plate and the far end of the elongated recess misaligns with any of the passages, a fluid communication is established among the first inlet, the third inlet, the first passage, the second inlet of the resin tank and the resin tank to turn hard water into softened water.

A further objective of the embodiment of the present invention is that the dynamic valve plate is rotated to a position where the third inlet is communicating with the fourth passage of the static valve plate and the far end of the elongated recess aligns with the third passage to communicate the third passage with the second discharge, a fluid communication is established among the first inlet, the third inlet, the second outlet of the resin tank and an interior of the resin tank for cleansing resin plates inside the resin tank.

A further objective of the embodiment of the present invention is that the dynamic valve plate is rotated to a position where the third inlet is communicating with the fifth passage of the static valve plate and the far end of the elongated recess aligns with the first passage to communicate with the second discharge, a fluid communication is established among the first inlet, the third inlet, the main inlet of the ejector to allow water to be mixed with salt water flowing from the brine tank via the negative pressure inlet of the ejector for refreshing resin plates inside the resin tank.

A further objective of the embodiment of the present invention is that the dynamic valve plate is rotated to a position where the third inlet is communicating with the second passage of the static valve plate and the far end of the elongated recess aligns with the fourth passage to communicate the fourth passage with the second discharge, a fluid communication is established among the first inlet, the third inlet, the second passage, the second inlet and an interior of the resin tank.

A further objective of the embodiment of the present invention is that the dynamic valve plate is rotated to a position where the third inlet is communicating with the sixth passage of the static valve plate and the far end of the elongated recess aligns with the fifth passage to communicate the fifth passage with the second discharge, a fluid communication is established among the first inlet, the third inlet, the sixth passage and the main inlet, the negative pressure inlet and an interior of the brine tank.

### BRIEF DESCRIPTION OF THE DRAWINGS

FIG. 1 is a schematic cross sectional view of the water softener valve mechanism constructed in accordance with the preferred embodiment of the present invention;

FIG. 2 is still a schematic cross sectional view of the water softener valve mechanism of the preferred embodiment of the present invention in a direction different from that of FIG. 1;

FIG. 3 is a top plan view of the valve mechanism of the preferred embodiment of the present invention;

FIG. 4 is a side plan view of the valve mechanism of the preferred embodiment of the present invention;

FIG. 5 is a top plan view showing the static valve plate of the preferred embodiment of the present invention;

FIG. 6 is a top plan view showing the dynamic valve plate of the preferred embodiment of the present invention;

FIG. 7 is a perspective view showing the mechanism driving the movement of the dynamic valve plate of the preferred embodiment of the present invention;

FIGS. 8-12 are schematic top plan views showing relationships between the dynamic valve plate and the static valve plate in different phases;

FIG. 13 is a perspective view showing the location of the static valve plate relative to the valve mechanism of the preferred embodiment of the present invention; and

FIG. 14 is still a perspective view showing the location of the static valve plate in another angle relative to the valve mechanism of the preferred embodiment of the present invention.

### DETAILED DESCRIPTION OF THE PREFERRED EMBODIMENT

Preferred embodiment(s) of the present invention in combination with the attached drawings shall be provided in detail in the following description. However, the given description is for example purpose only and should not be deemed as a limiting to the scope of the present invention in any way.

In order to make it easy to carry out the preferred embodiment of the present invention, a detailed description of the parts of the invention, supported with figures is provided here. As each part of the preferred embodiment of the present invention has many features, it is made easy to read, by referring to each feature with a number included in the parts description text. The number of the parts feature(s) is indicated here by starting it sequentially from the number 100, wherever a part feature appears in a text, it is directly assigned its associated serial number.

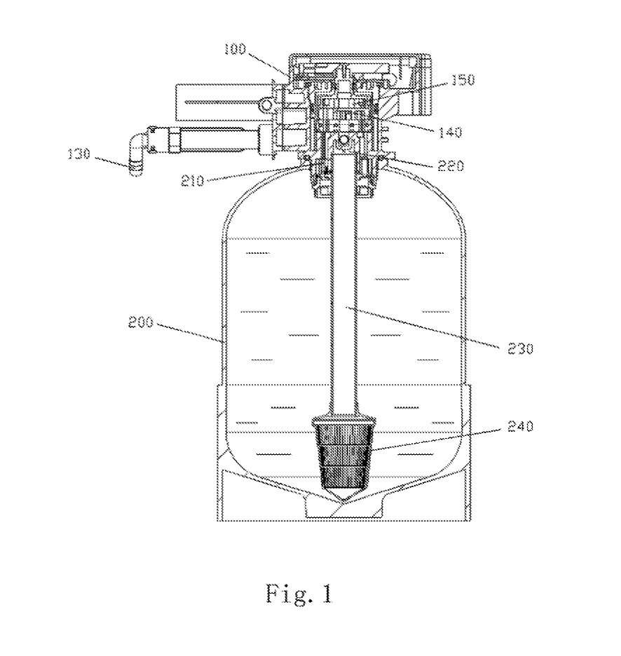

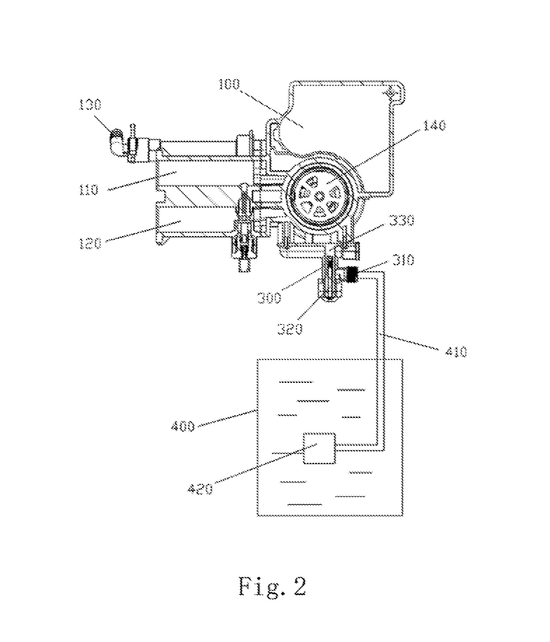

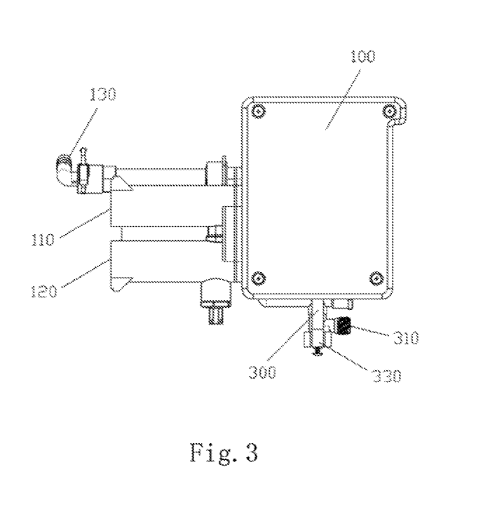

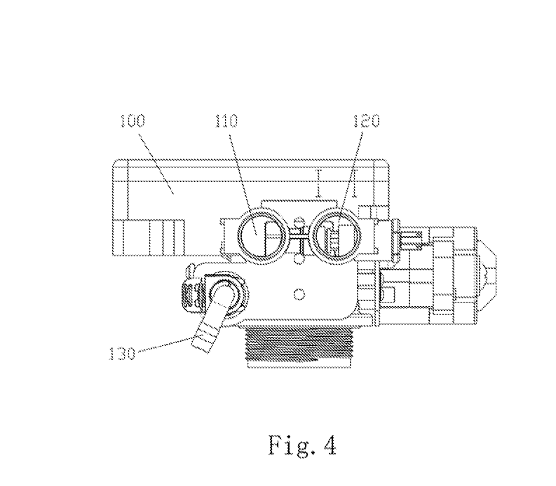

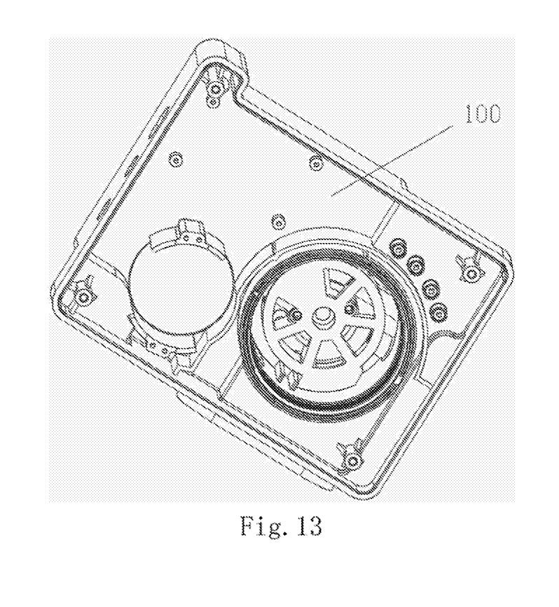

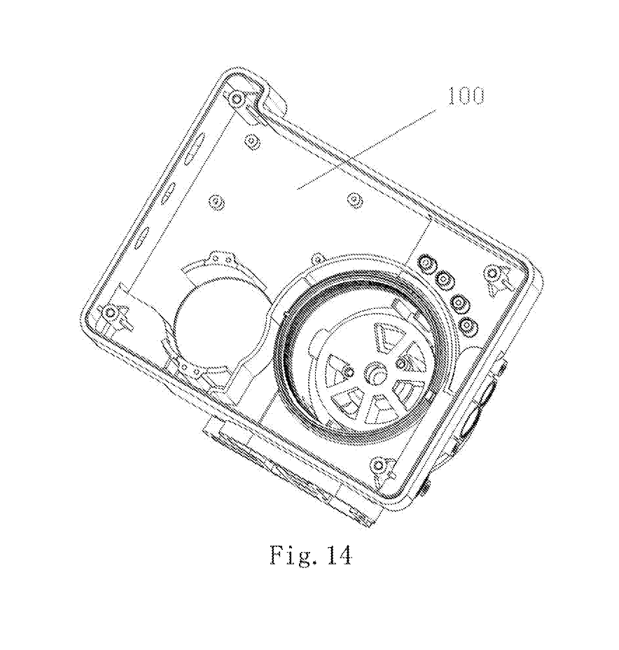

With reference to FIGS. 1-4, 13 and 14, It is to be noted that the water softener valve mechanism constructed in accordance with the present invention has a body 100 provided with therein a first inlet 110, a first outlet 120 and a discharge 130. The body 100 of the valve mechanism of the preferred embodiment of the present invention is adapted to connect to a resin tank 200 and has an ejector 300 adapted to connect to a brine tank 400 having salt water therein. The ejector 300 has a negative pressure inlet 310, an ejection outlet 320 and a main inlet 330. The negative pressure inlet 310 is in fluid communication with the brine tank 400 via a salt pipe 410 extending from the brine tank 400 to the negative pressure inlet 310. The resin tank 200 has a second inlet 210, a second outlet 220 connected to a central tube 230 extending into an interior of the resin tank 200 and provided with a distributor 240 at a free end thereof.

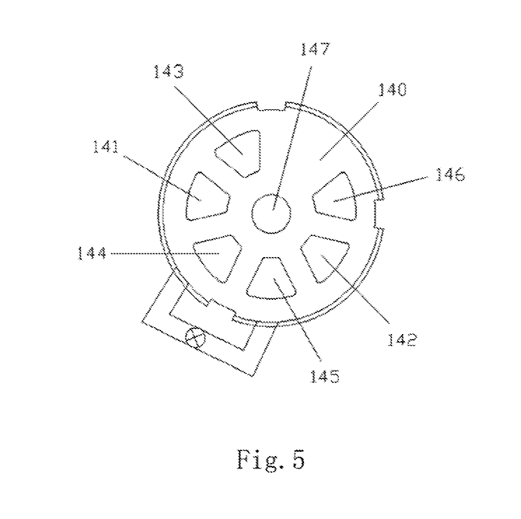

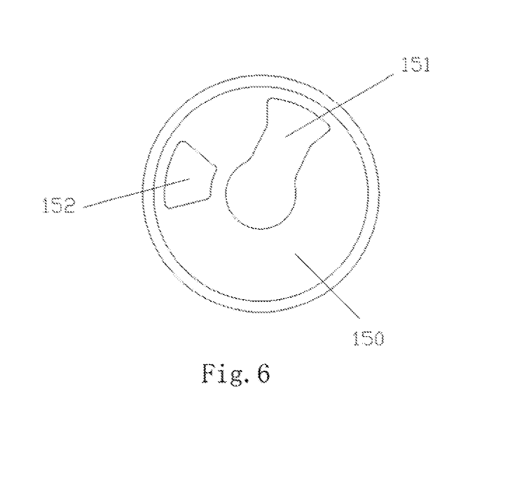

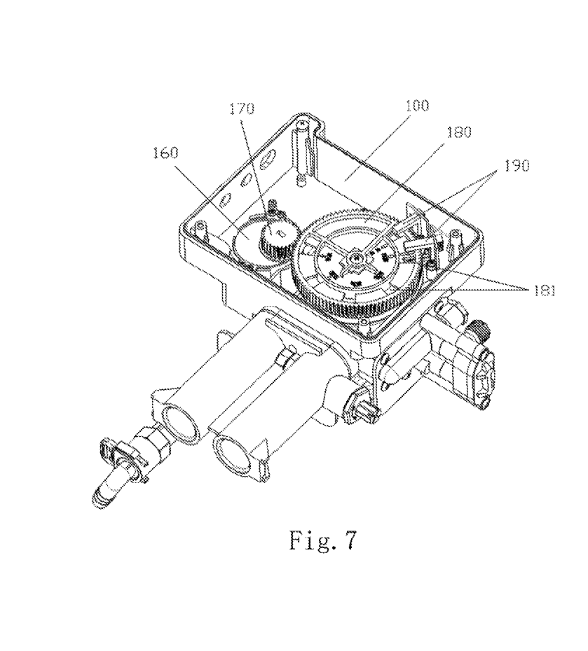

In addition, a static valve plate 140 and a dynamic valve plate 150, as shown in FIGS. 5 and 6, are provided inside the body 100 of the water softener valve mechanism of the preferred embodiment of the present invention. The dynamic valve plate 150 is rotatably operative relative to the static valve plate 140 so as to channel different waterways to process different phases of the water softening. Furthermore, to drive the dynamic valve plate 150 to rotate in according to different requirements in various water softening phases of the water softener, a motor 160, as shown in FIG. 7, is provided inside the body 100 to drive a master gear 170 which is meshed with a planetary gear 180. The planetary gear 180 has an axel (not shown) connected to the dynamic valve plate 150 such that the operation of the motor 160 is able to drive the dynamic valve plate 150 to rotate accordingly. Still, with reference to FIG. 7, inside the body 100, there are provided with photo sensors 190 and photo pads 181 are spatially separated from each other and mounted on a face of the planetary gear 180 such that when the planetary gear 180 is rotated due to the operation of the motor 160, the photo sensors 190 are able to detect the angular position of the planetary gear 180, which specifically locate the corresponding angular position of the dynamic valve plate 150.

Referring to FIGS. 5 and 6, it is noted that the static valve plate 140 could be in any shape, preferably in circular shape, as shown in the attached drawing of FIG. 5. The static valve plate 140 has a first passage 141 defined to selectively communicate with the second inlet 210 of the brine tank 200, a second passage 142 defined to selectively communicate with the second inlet 210 of the brine tank 200, a third passage 143 defined also to selectively communicate with the second inlet 219 of the brine tank 200, a fourth passage 144 provided therein a first check valve (not numbered) and defined to selectively communicate with the first outlet 120 of the body 100, the second outlet of the brine tank 200 and the ejection outlet 320 of the ejector 300, a fifth passage 145 defined to selectively communicate with the main inlet 330 and provided therein a second check valve (not shown), a six passage 146 provided therein a third check valve (not shown) and defined to selectively communicate with the main inlet 330 and a second discharge 147 communicating with the first discharge 130 of the body 100. It is noted from, for example, FIG. 5 that the first passage 141, the second passage 142, the third passage 143, the fourth passage 144, the fifth passage 145 and the sixth passage 146 are arranged on the static valve plate 140 and spatially apart from one another. Especially, the sequence of the passages 141˜146 is, in a clockwise direction, the first passage 141, the third passage 143, the sixth passage 146, the second passage 142, the fifth passage 145 and the fourth passage 144, wherein an additional space is sandwiched between the third passage 143 and the sixth passage 146. The dynamic valve plate 150 is mounted on top of the static valve plate 140 and has an elongated recess 151 defined in a direction parallel to a radial direction of the dynamic valve plate 150 and a third inlet 152 defined through the surface of the dynamic valve plate 150 to communicate with the first inlet 110 of the body 100. The shape of the second discharge 147 of the static valve plate 140 is corresponding to that of a central portion of the elongated recess 151 and the central portion of the elongated recess 151 is constantly located on top of the second discharge 147 of the static valve plate 140. Due to the rotational ability of the dynamic valve plate 150, a far end of the third inlet 152 is able to selectively communicate with the passages, i.e., 141˜146 respectively. When the far end of the third inlet 152 is moved to the space between the third passage 143 and the sixth passage 146, the far end of the third inlet 152, the end that is away from the central portion of the third inlet, does not communicate with any of the passages 141˜146.

As stated earlier that the dynamic valve plate 150 is rotatable due to the driving force provided by the planetary gear 180, as shown in FIG. 7 and the photo sensors 190 are able to precisely detect the angular position of the dynamic valve plate 150 after rotation, as such, the rotational angle of the dynamic valve plate 150 is able to be precisely controlled.

Furthermore, it is understood that there are filtering phase, reverse cleaning phase, regenerating phase, cleaning phase and water supplementing phase in a water softener. The following description is aimed at providing a detailed operational process of the relationship between the static valve plate 140 and the dynamic valve plate 150 as well as the waterways in the valve mechanism.

### Filtering Phase

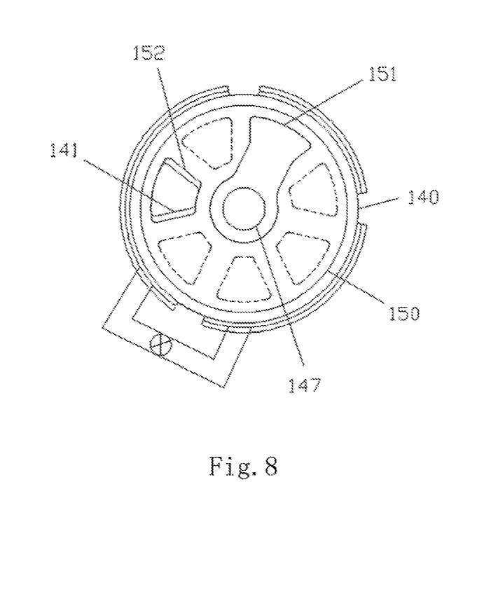

With reference to FIG. 8, when the valve mechanism of the embodiment of the present invention is in a filtering phase, the dynamic valve plate 150 is rotated to a position where the third inlet 152 is communicating with the first passage 141 of the static valve plate 140 and the far end of the elongated recess 151 misaligns with any of the passages, i.e., 141˜146, water flows from the first inlet 110 and passes through the third inlet 152, the first passage 141, the second inlet 210 of the resin tank 200 and eventually enters the resin tank 200 to turn hard water into softened water. After water is softened, the soft water flowing through the central tube 230 passes the second outlet 220 and exits from the first outlet 120 for use by the user.

### Reverse Cleaning

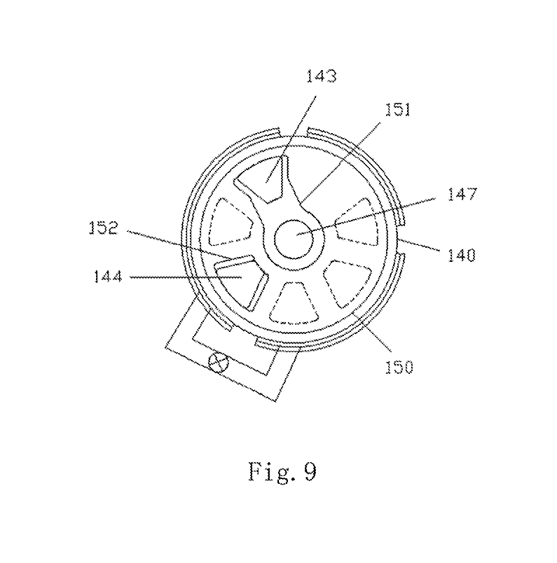

With reference to FIG. 9, when the valve mechanism of the embodiment of the present invention is in a reverse cleaning phase, the dynamic valve plate 150 is rotated to a position where the third inlet 152 is communicating with the fourth passage 144 of the static valve plate 140 and the far end of the elongated recess 151 aligns with the third passage 143, which communicates the third passage 143 with the second discharge 147. Water flows from the first inlet 110 and passes through the third inlet 152, the second outlet 220 of the resin tank 200 and eventually enters the resin tank 200 to cleanse the resin plates inside the resin tank 200, after which the used water flows through the second inlet 210 of the resin tank 200, the third passage 143 of the static valve plate 140 and exits from the discharge 130 of the body 100.

### Regenerating Phase

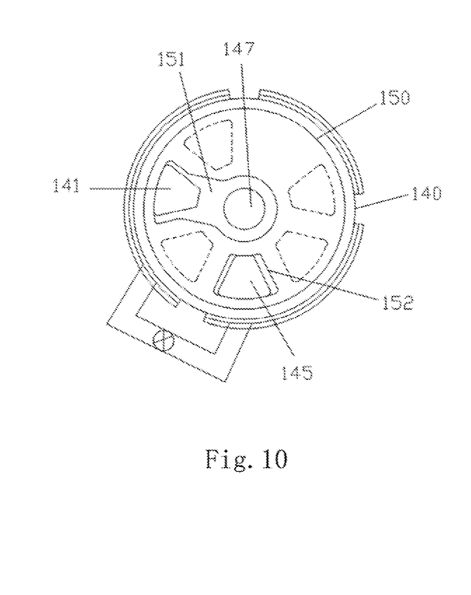

With reference to FIG. 10, when the valve mechanism of the embodiment of the present invention is in a regenerating phase, the dynamic valve plate 150 is rotated to a position where the third inlet 152 is communicating with the fifth passage 145 of the static valve plate 140 and the far end of the elongated recess 151 aligns with the first passage 141 to communicate with the second discharge 147, water flows from the first inlet 110 and passes through the third inlet 152 and the main inlet 330 of the ejector 300 to mix with salt water flowing from the negative pressure inlet 310 of the ejector 300 so as refresh the resin plates, after which, the water then flows through the second inlet 210 of the resin tank 200 and exits the discharge 130.

### Cleansing Phase

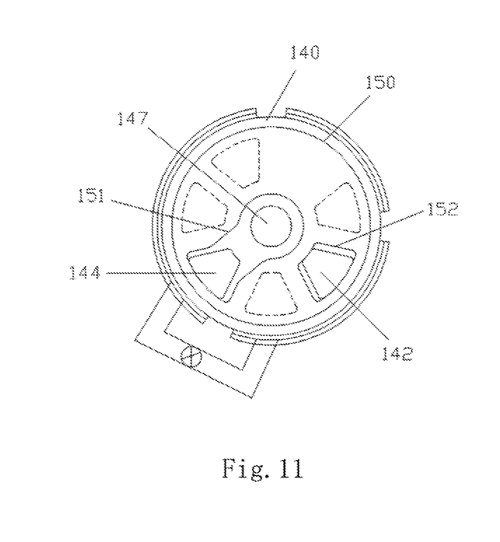

With reference to FIG. 11, when the valve mechanism of the embodiment of the present invention is in a cleansing phase, the dynamic valve plate 150 is rotated to a position where the third inlet 152 is communicating with the second passage 142 of the static valve plate 140 and the far end of the elongated recess 151 aligns with the fourth passage 144 so as to communicate the fourth passage 144 with the second discharge 147, water flows from the first inlet 110 and passes through the third inlet 152, the second passage 142, the second inlet 210 and enters the resin tank 200. Then, the water flows through the central tube 230, the second outlet 220, the fourth passage 144 and exits the discharge 130.

### Water Supplementing Phase

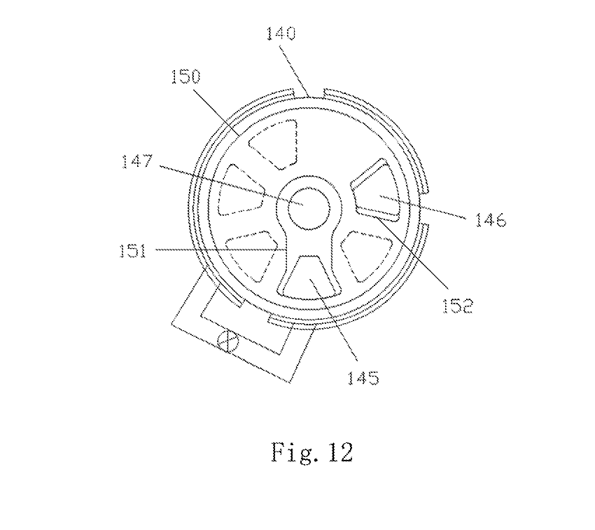

With reference to FIG. 12, when the valve mechanism of the embodiment of the present invention is in a cleansing phase, the dynamic valve plate 150 is rotated to a position where the third inlet 152 is communicating with the sixth passage 146 of the static valve plate 140 and the far end of the elongated recess 151 aligns with the fifth passage 145 so as to communicate the fifth passage 145 with the second discharge 147, water flows from the first inlet 110 and passes through the third inlet 152, the sixth passage 146 and enters the main inlet 330. After passing through the negative pressure inlet 310, water flows into the brine tank 400.

In the regenerating phase, when the salt water inside the brine tank 400 is below a previously determined level, the valve 420 inside the brine tank 400 automatically shut down, where in the water supplementing phase, the water entering the ejector 300 forces the valve 420 to turn on.

Again, in the regenerating phase, water is flowing in a reverse manner, for example, flowing from the first inlet 110 and passes through the third inlet 152 and the main inlet 330 of the ejector 300 to mix with salt water flowing from the negative pressure inlet 310 of the ejector 300 so as float/refresh the resin plates, after which, the water then flows through the second inlet 210 of the resin tank 200 and exits the discharge 130.

After a detailed description of the preferred embodiment(s) has been provided, any skilled person in the art would easily understand the description so provided is for example purpose only. The scope for protection of the present invention is defined by the attached claims. Any skilled person in the art would easily amend, modify or alter the elements/devices of the present invention without departing from the principle essence and spirit of the present invention. However, the amendment, modification or alteration shall fall within the protection scope sought of the present invention.

What is claimed is:

1. A water softener valve mechanism comprising:
a body provided with a first inlet, a first outlet and a first discharge, the body further having therein:
a static valve plate provided with a first passage, a second passage, a third passage, a fourth passage, a fifth passage and a sixth passage respectively and radially defined through a surface of the static valve plate and a second discharge defined through a central portion of the static valve plate to have the first passage, the second passage, the third passage, the fourth passage, the fifth passage and the sixth passage radially located around the second discharge; and
a dynamic plate rotatable relative to the static plate and having an elongated recess defined in a side face of the dynamic plate and a third inlet in communication with the first inlet of the body and to selectively communicate with the first passage, the second passage, the third passage, the fourth passage, the fifth passage and the sixth passage; and
a driving device mounted inside the body to drive the dynamic valve plate to rotate.

2. The water softener valve mechanism as claimed in claim 1, wherein the driving device includes a motor, a master gear securely connected to the motor to be rotatable relative to the motor, and a planetary gear meshed with the master gear to be driven by the master gear, the planetary gear is securely connected to the dynamic valve plate to provide a driving force to the dynamic valve plate to rotate relative to the static valve plate.

3. The water softener valve mechanism as claimed in claim 2 further having a plurality photo sensors mounted inside the body and photo pads mounted on the planetary gear to allow the photo sensors to detect angular positions of the dynamic valve plate after rotation.

4. The water softener valve mechanism as claimed in claim 2 further having check valves installed respectively in the fourth passage, the fifth passage and the sixth passage.

5. A water softener system comprising:
a body having a first inlet, a first outlet, a static valve plate immovably located inside the body and having multiple passages radially defined through a face of the static valve plate and a second discharge centrally defined through the face thereof to have the second discharge surrounded by the passages and a dynamic valve plate movable relative to the static plate and having a third inlet selectively communicating with the first inlet and one of the passages of the static valve plate and an elongated recess with a central portion thereof aligned and communicating with the second discharge and a far end thereof either selectively communicating with one of the passages or having no communication with any of the passages while the third inlet is still aligned and communicating with one of the passages;
an ejector securely mounted on the body and having a main inlet selectively communicating with the first inlet of the body and a negative pressure inlet selectively communicating with the main inlet;
a resin tank having a second inlet selectively communicating with the first inlet of the body, a second outlet selectively communicating with the first inlet and the discharge of the body; and
a brine tank having a salt pipe extending outwardly to selectively communicate with the negative pressure inlet of the ejector such that movement of the dynamic valve plate allows the communication between the third inlet and one of the passages of the static valve plate to have various fluid communications in filtering phase, reverse phase, regenerating phase, cleansing phase and water supplementing phase.

6. The water softener system as claimed in claim 5, wherein the passages of the static valve plate include a first passage, a second passage, a third passage, a fourth passage, a fifth passage and a sixth passage respectively and radially defined through the face of the static valve plate.

7. The water softener system as claimed in claim 6 further comprising a driving device mounted inside the body to drive the dynamic valve plate to move.

8. The water softener system as claimed in claim 7, wherein the driving device includes a motor, a master gear securely connected to the motor to be rotatable relative to the motor, and a planetary gear meshed with the master gear to be driven by the master gear, the planetary gear is securely connected to the dynamic valve plate to provide a driving force to the dynamic valve plate to rotate relative to the static valve plate.

9. The water softener system as claimed in claim 8 further having a plurality photo sensors mounted inside the body and photo pads mounted on the planetary gear to allow the photo sensors to detect angular positions of the dynamic valve plate after rotation.

10. The water softener system as claimed in claim 6 further having check valves installed respectively in the fourth passage, the fifth passage and the sixth passage.

11. The water softener system as claimed in claim 9, wherein the dynamic valve plate is rotated to a position where the third inlet is communicating with the first passage of the static valve plate and the far end of the elongated recess misaligns with any of the passages, a fluid communication is established among the first inlet, the third inlet, the first passage, the second inlet of the resin tank and the resin tank to turn hard water into softened water.

12. The water softener system as claimed in claim 9, wherein the dynamic valve plate is rotated to a position where the third inlet is communicating with the fourth passage of the static valve plate and the far end of the elongated recess aligns with the third passage to communicate the third passage with the second discharge, a fluid communication is established among the first inlet, the third inlet, the second outlet of the resin tank and an interior of the resin tank for cleansing resin plates inside the resin tank.

13. The water softener system as claimed in claim 9, wherein the dynamic valve plate is rotated to a position where the third inlet is communicating with the fifth passage of the static valve plate and the far end of the elongated recess aligns with the first passage to communicate with the second discharge, a fluid communication is established among the first inlet, the third inlet, the main inlet of the ejector to allow water to be mixed with salt water flowing from the brine tank via the negative pressure inlet of the ejector for refreshing resin plates inside the resin tank.

14. The water softener system as claimed in claim 9, wherein the dynamic valve plate is rotated to a position where the third inlet is communicating with the second passage of the static valve plate and the far end of the elongated recess aligns with the fourth passage to communicate the fourth passage with the second discharge, a fluid communication is established among the first inlet, the third inlet, the second passage, the second inlet and an interior of the resin tank.

15. The water softener system as claimed in claim 9, wherein the dynamic valve plate is rotated to a position where the third inlet is communicating with the sixth passage of the static valve plate and the far end of the elongated recess aligns with the fifth passage to communicate the fifth passage with the second discharge, a fluid communication is established among the first inlet, the third inlet, the sixth passage and the main inlet, the negative pressure inlet and an interior of the brine tank.

16. The water softener system as claimed in claim 11, wherein the dynamic valve plate is rotated to a position where the third inlet is communicating with the fourth passage of the static valve plate and the far end of the elongated recess aligns with the third passage to communicate the third passage with the second discharge, a fluid communication is established among the first inlet, the third inlet, the second outlet of the resin tank and an interior of the resin tank for cleansing resin plates inside the resin tank.

17. The water softener system as claimed in claim 16, wherein the dynamic valve plate is rotated to a position where the third inlet is communicating with the fifth passage of the static valve plate and the far end of the elongated recess aligns with the first passage to communicate with the second discharge, a fluid communication is established among the first inlet, the third inlet, the main inlet of the ejector to allow water to be mixed with salt water flowing from the brine tank via the negative pressure inlet of the ejector for refreshing resin plates inside the resin tank.

18. The water softener system as claimed in claim 17, wherein the dynamic valve plate is rotated to a position where the third inlet is communicating with the second passage of the static valve plate and the far end of the elongated recess aligns with the fourth passage to communicate the fourth passage with the second discharge, a fluid communication is established among the first inlet, the third inlet, the second passage, the second inlet and an interior of the resin tank.

19. The water softener system as claimed in claim 18, wherein the dynamic valve plate is rotated to a position where the third inlet is communicating with the sixth passage of the static valve plate and the far end of the elongated recess aligns with the fifth passage to communicate the fifth passage with the second discharge, a fluid communication is established among the first inlet, the third inlet, the sixth passage and the main inlet, the negative pressure inlet and an interior of the brine tank.
